(19) United States
(12) Patent Application Publication
(10) Pub. No.: US 2005/0201078 A1
(43) Pub. Date: Sep. 15, 2005

(54) Lighting system with a passive phosphorescent light source

(76) Inventor: Michael E. Hannington, Madison, OH (US)

Correspondence Address: Cynthia S. Murphy;Renner, Otto, Boisselle & Sklar, LLP, Nineteenth Floor, 1621 Euclid Avenue, Cleveland, OH, 44115, US

(21) Appl. No.: 11/055,159

(22) Filed: Feb. 10, 2005

Related U.S. Application Data
(60) Provisional application No. 60/552,593, filed on Mar. 12, 2004.
(60) Provisional application No. 60/619,778, filed on Oct. 18, 2004.
(60) Provisional application No. 60/623,016, filed on Oct. 28, 2004.

(51) Int. Cl. F21V 7/00

(52) U.S. Cl. 362/34

(57) ABSTRACT

A lighting system (10) comprising a primary light source (12) for supplying primary light to a viewing environment and a passive light source (14) for supplying light to the viewing environment when the primary light source (12) is unavailable and the viewing environment is dark. The passive light source (14) comprises a substrate (30) carrying a phosphorescent material (34), and this phosphorescent-carrying substrate (30) is positioned between the primary light source (12) and the viewing environment. The substrate (30) has an optical transmittance of at least 50% (whereby primary light from the primary light source (12) can be transmitted therethrough to the viewing environment) and an optical emission of at least 15.0 mcd/m² at ten minutes.

### RELATED APPLICATIONS

This application claims priority to U.S. Provisional Patent Application Nos. 60/552,593, 60/619,778, and 60/623,016 filed on Mar. 12, 2004, Oct. 18, 2004, and Oct. 28, 2004 respectively. The entire disclosures of these earlier applications are hereby incorporated by reference.

### FIELD OF THE INVENTION

This invention relates generally, as indicated, to a lighting system with a passive phosphorescent light source and, more particularly, to a lighting system comprising a primary light source for supplying primary light to a viewing environment and a passive phosphorescent light source for supplying light to the viewing environment in the absence or minimization of the primary light.

### BACKGROUND OF THE INVENTION

Phosphorescent material is commonly employed in a passive light source to provide light when a primary source of light (e.g., an electrically powered light source and/or sunlight) is unavailable. When primary light is being supplied to a viewing environment by the primary light source, the phosphorescent material absorbs this primary light and then emits the absorbed light upon the absence or minimization of the primary light. The phosphorescent material is carried by some type of substrate and, conventionally, this substrate has had a low optical transmittance, whereby light from the primary light source could not be effectively transmitted therethrough. Accordingly, the passive light source could not be positioned between the primary light source and the viewing environment, as such a positioning would compromise the transmission of primary light.

### SUMMARY OF THE INVENTION

The present invention provides a passive light source wherein the phosphorescent-carrying substrate has a high optical transmittance so that the passive light source can be positioned between a primary light source and a viewing environment without compromising the transmission of primary light.

More particularly, the present invention provides a lighting system comprising a primary light source for supplying primary light to a viewing environment and a passive light source for supplying light to the viewing environment when the primary light source is unavailable. The primary light source may be electrically powered or sunlight.

The passive light source comprises a substrate which carries a phosphorescent material and which is positioned between the primary light source and the viewing environment. The substrate has an optical transmittance of at least 50%, at least 60%, at least 70%, and/or at least 80%, whereby primary light from the primary light source can be transmitted therethrough to the viewing environment. Preferably, the substrate has an optical emission of at least 15.0 mcd/m², at least 20 mcd/m², at least 30 mcd/m², at least 40 mcd/m², and/or at least 50 mcd/m² (at ten minutes). The phosphorescent material may be coated on the substrate or embedded therein at a density corresponding to the desired optical transmittance and emission. The substrate can comprise, for example, a film, a cover, an envelope (i.e., a bulb), and/or a window-pane.

These and other features of the invention are fully described and particularly pointed out in the claims. The following description and drawings set forth in detail certain illustrative embodiments of the invention, which are indicative of but a few of the various ways in which the principles of the invention may be employed.

### DRAWINGS

FIG. 1 is a lighting system according to a first embodiment of the present invention.

FIG. 1A is a close-up view of a phosphorescent-carrying substrate of the lighting system of FIG. 1.

FIGS. 1B-1E are plan views of the phosphorescent-carrying substrate of the lighting system of FIG. 1.

FIG. 2 is a lighting system according to a second embodiment of the present invention.

FIG. 3 is a lighting system according to a third embodiment of the present invention.

FIG. 3A is a close-up view of a phosphorescent-carrying substrate of the lighting system of FIG. 3.

FIGS. 3B-3E are plan views of the phosphorescent-carrying substrate of the lighting system of FIG. 3.

FIG. 4 is a lighting system according to a fourth embodiment of the present invention.

FIG. 4A is a close-up view of a phosphorescent-carrying substrate of the lighting system of FIG. 4.

FIG. 5 is a lighting system according to a fifth embodiment of the present invention.

FIG. 5A is a close-up view of a phosphorescent-carrying substrate of the lighting system of FIG. 5.

FIG. 6 is a lighting system according to a sixth embodiment of the present invention.

FIG. 6A is a close-up view of a phosphorescent-carrying substrate of the lighting system of FIG. 6.

FIG. 7 is a lighting system according to a seventh embodiment of the present invention.

FIG. 7A is a close-up view of a phosphorescent-carrying substrate of the lighting system of FIG. 7.

FIG. 8 is a lighting system according to an eighth embodiment of the present invention.

FIG. 8A is a close-up view of a phosphorescent-carrying substrate of the lighting system of FIG. 8.

### DETAILED DESCRIPTION

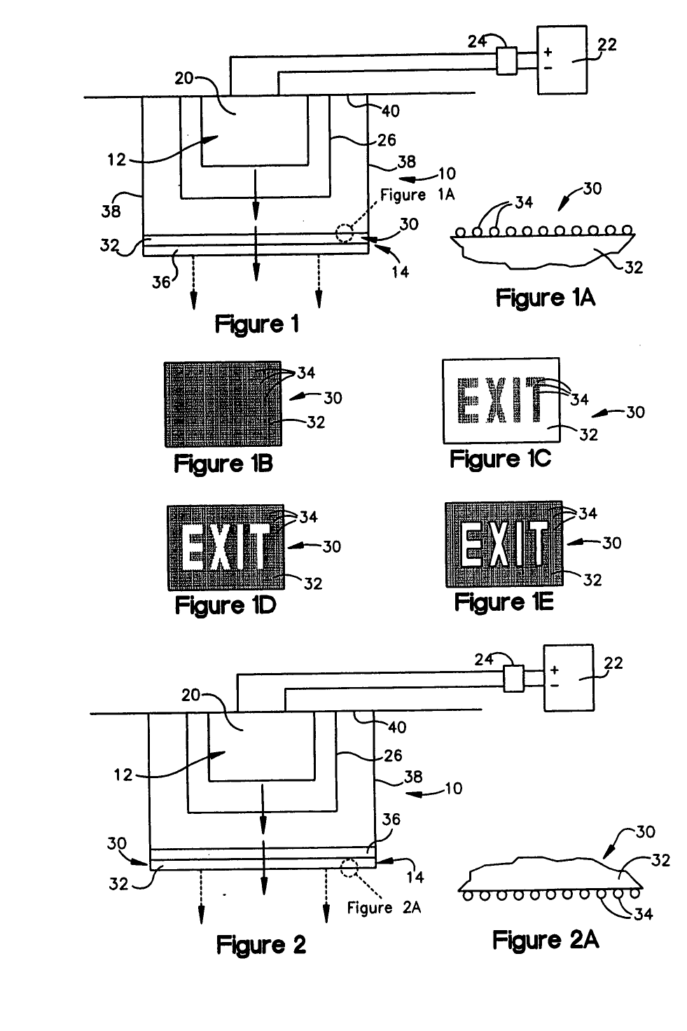

Referring now to the drawings, and initially to FIG. 1, a lighting system 10 according to a first embodiment of the invention is shown. The lighting system 10 comprises a primary light source 12 for supplying primary light (solid arrows) to a viewing environment and a passive light source 14 for supplying light (dashed arrows) to the viewing environment when primary light is not being supplied from the source 12 and the viewing environment is dark.

The primary light source 12 can comprise lighting components 20 that are electrically powered by a power source 22 and can be turned on/off by a switch 24. For example, if the lighting system 10 includes an incandescent light bulb, the electrical components 20 can comprise a filament electrically connected to the power source 22. If the lighting system 10 includes a fluorescent light bulb, the electrical components 20 can comprise a transformer ballast electrically connected to the power source 22 and a fluorescent tube. In either event, a glass or plastic envelope 26 (i.e., “bulb”) can surround the lighting components 20.

Primary light will be supplied by the primary light source when the power source 22 is capable of providing power and when the switch 24 is in the “on” position. Thus, primary light will not be supplied by the source 12 when the switch is purposely placed in the off position. Additionally and alternatively, light will not be supplied by the primary light source 12 when the power source is not providing power (i.e., during power outage).

The passive light source 14 comprises a phosphorescent-carrying substrate 30. In the embodiment illustrated in FIG. 1, the substrate 30 comprises a film 32 made from a clear polymer (e.g., Polycarbonate, PMMA, Urethane, Vinyl, etc.)which has the phosphorescent particles 34 coated thereon. (See FIG. 1A.) Typically, phosphorescent particles are dispersed in a clear polymer to facilitate application and to protect the pigment from the environment. The phosphorescent particles 34 absorb and store light radiated thereupon and, in the absence of ambient or artificial light, will emit phosphorescence to provide passive lighting. The particles 34 are shown coated on the upper surface of the film 32 but could instead or additionally be coated on the film's lower surface.

The phosphorescent coating may be equally distributed over the surface area of the film 32 so that its light radiation is substantially uniform. (See FIG. 1B.) Alternatively, the phosphorescent coating may distributed on the film 32 to provide useful indicia (e.g., EXIT, arrows pointing to an exit, etc.) during dark conditions by the indicia areas being coated and the remaining areas uncoated (see FIG. 1C) or by the indicia areas being uncoated and the remaining areas being coated (see FIG. 1D). Another option is to cut-out the indicia areas from the coated film 32, whereby they will appear dark compared to the remaining areas. (See FIG. 1E.)

The substrate 30 is positioned between the primary light source 12 and the viewing environment and, more particularly, on an upper surface of a cover 36. The cover 36 may be transparent and its purpose merely to protect interior components from dust and damage and/or for decorative reasons. Alternatively, the cover 36 may function to diffuse light by incorporating prisms, reflectors, frosting, and/or light-scattering particulate.

In the lighting system 10 illustrated in FIG. 1, the cover 36 forms a bottom wall of the lighting fixture, and the fixture may also include side walls 38 and a top wall 40. The walls 38 and/or the wall 34 may be provided with a phosphorescent coating and/or reflective coating to further enhance the passive light emission. Also, it may be appreciated that if the cover 36 formed the top wall or side wall of the light fixture, the remaining walls could be provided with a phosphorescent coating and/or reflective coating for the same reason.

Referring now to FIG. 2, a lighting system 10 according to a second embodiment of the invention is shown. In this embodiment, the phosphorescent-carrying substrate 30 comprises a polymer film 32 (which has the phosphorescent particles 34 coated thereon) and is positioned on a lower surface of the cover 36. The film 32 could be coated in the same manner as explained above in reference to FIGS. 1B-1E.

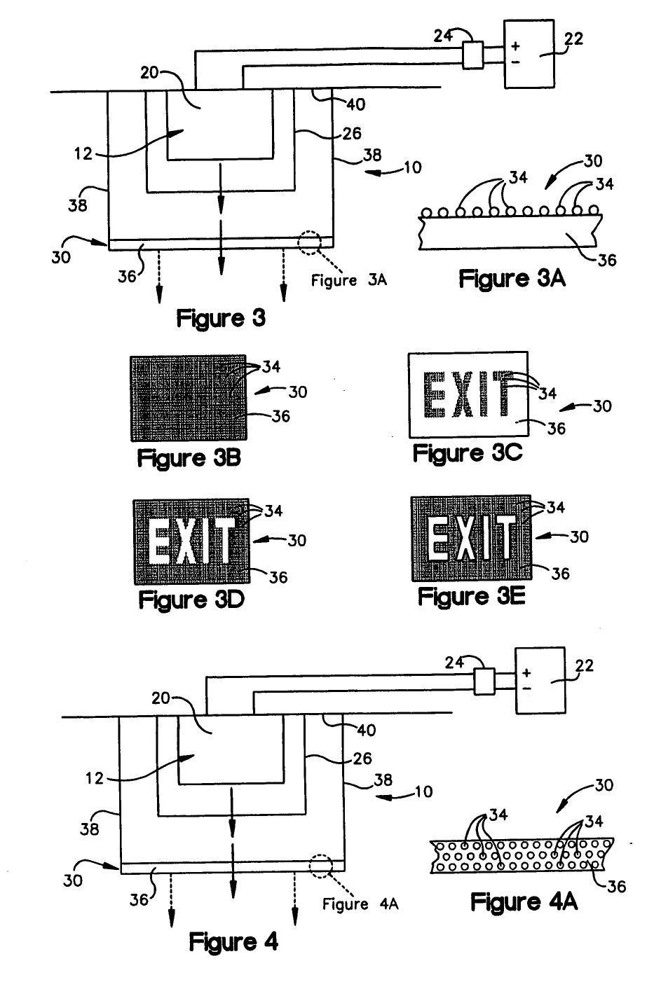

Referring now to FIG. 3, a lighting system 10 according to a third embodiment of the invention is shown. In this embodiment, the cover 36 itself is the phosphorescent-carrying substrate 30 and the phosphorescent particles 34 are coated thereon. (See FIG. 3A.) The coating of the cover 36 could be accomplished in such a manner so as to provide uniform lighting during dark conditions (see FIG. 3B) or to provide helpful indicia (see FIGS. 3C-3E) in the same manner as with the film 32 in the first and second embodiments.

Referring now to FIG. 4, a lighting system 10 according to a fourth embodiment of the invention is shown. In this embodiment, the cover 36 is again the phosphorescent-carrying substrate 30, but the phosphorescent particles 34 are embedded or otherwise incorporated therein. (See FIG. 4A.) For example, if the cover 36 is made in a thermoplastic process, the particles 34 could be introduced into the liquid composition prior to molding, curing, and/or setting. Portions of the cover 36 could be cut out to provide helpful indicia during dark conditions, such as is shown in FIG. 3E of the third embodiment.

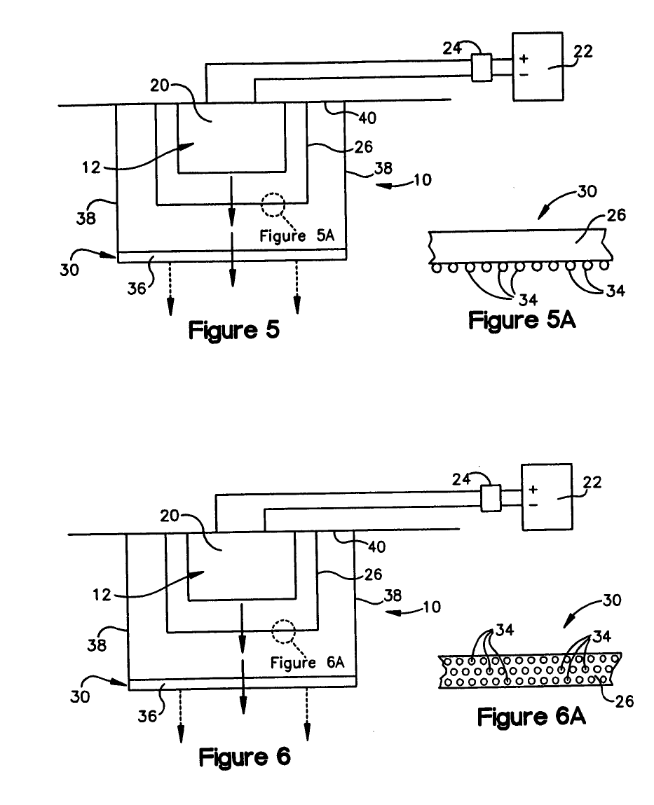

Referring now to FIG. 5, a lighting system 10 according to a fifth embodiment of the invention is shown. In these embodiments, the lamp envelope 26 is the phosphorescent-carrying substrate 30 and the phosphorescent particles 34 are coated thereon. (See FIG. 5A.) This embodiment allows a conventional light fixture to be quickly converted to a lighting system 10 by simply changing the light bulb surrounding the primary light source 12.

Referring now to FIG. 6, a lighting system 10 according to a sixth embodiment of the invention is shown. In this embodiment, the lamp envelope 26 is again the phosphorescent-carrying substrate, but the phosphorescent particles 34 are embedded or otherwise incorporated therein. (See FIG. 6A.) As with the cover 36 in the fourth embodiment, the particles 34 can be introduced during the formation stages of the envelope 26.

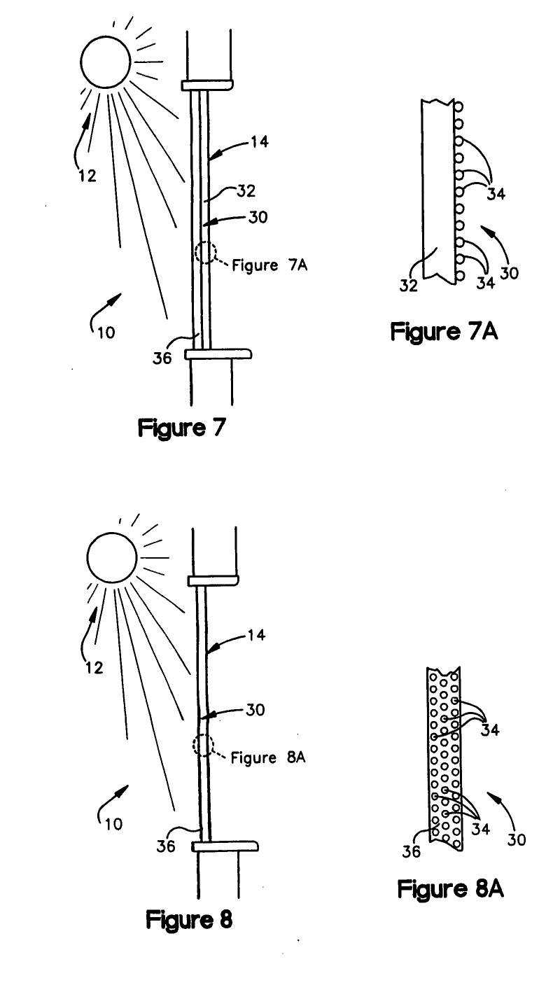

Referring now to FIG. 7, a lighting system 10 according to a seventh embodiment of the present invention is shown. In this lighting system 10, the source of primary light 12 is sunlight, which shines through a window-pane 36 to the viewing environment. Thus, primary light will be provided by the primary light source 12 during daylight hours and will not be supplied by the source 12 during nighttime hours. The phosphorescent-carrying substrate 30 comprises a polymer film 32 which has the phosphorescent particles 34 coated thereon. (See FIG. 7A.) The coating can be accomplished in the same manner as explained above in connection with the first embodiment of the invention and as shown in FIGS. 1B-1E.

Referring now to FIG. 8, a lighting system 10 according to an eighth embodiment of the present invention is shown. The primary light source 12 is again sunlight, which shines through a window-pane 36 to the viewing environment. In this embodiment, the window-pane 36 is the phosphorescent-carrying substrate 30 and the phosphorescent particles 34 are embedded or otherwise incorporated therein. (See FIG. 8A.)

In each of the above-described embodiments, the phosphorescent-carrying substrate 30 has an optical transmittance of at least 50%, at least 60%, at least 70%, and/or at least 80%, whereby primary light from the primary light source 12 can be transmitted through the substrate/film 30/32 to the viewing environment. Optical transmittance refers to the ratio of the light transmitted by the primary light source to the light which passes through the phosphorescent-carrying substrate. An optical transmittance of 0% would correspond to a substrate which allows no optical transmission and an optical transmittance of 100% would correspond to a substrate which is completely transparent.

Also in each of the above described embodiments, the phosphorescent-carrying substrate 30 has an emission of at least 15.0 mcd/m² at ten minutes and at least 2 mcd/m² at sixty minutes, and/or it has an emission of at least 20.0 mcd/m² at ten minutes and at least 2.8 mcd/m² at sixty minutes. These emission levels are necessary to satisfy IMO and ASTM standards, respectfully, for emergency visibility requirements. The substrate 30 can have an emission of at least 30 mcd/m² at ten minutes, at least 40 mcd/m² at ten minutes, and/or at least 50 mcd/m² at ten minutes.

The phosphorescent material 34 can be a phosphorescent phosphor including a matrix expressed by MAl₂O₄ in which M is calcium, strontium, or barium or in which M is magnesium activated by calcium, strontium, barium, and/or europium. These phosphorescent phosphors show excellent photo-resistance and possess extremely long afterglow characteristics. Such phosphorescent phosphors are disclosed and described in U.S. Pat. No. 5,424,006, the entire disclosure of which is hereby incorporated by reference. Another phosphor having intense and persistent afterglow characteristics is disclosed in U.S. Pat. No. 5,770,111, the entire disclosure of which is also hereby incorporated by reference. By using intense and/or persistent phosphors, a low density can be used when coating the substrate 30 in the first, second, third, fifth, and seventh embodiments, and when incorporating the phosphors into the substrate material in the fourth, sixth and eighth embodiments. This low density corresponds to a high transmission, whereby high (or at least acceptable) emissions are accomplished without overly compromising transmission.

When the primary light source 12 is being used, the primary light is transmitted through the phosphorescent-carrying substrate 30 and through the cover 36 to the viewing environment. During primary light use, the phosphorescent particles 34 are “charged” so that when the primary light source 12 is not being used, and the viewing environment is dark, the stored light is emitted from the substrate 30 and through the cover 36 to the viewing environment. It may be noted that the positioning of the substrate 30 allows for maximum exposure of the phosphorescent material 34 to primary light in order to maximize charging.

By way of example, consider a sixteen-feet-by-sixteen-feet room having no outside windows and having four two-feet-by-four-feet fluorescent fixtures. According to the present invention, the existing diffusers in the fixtures could be replaced with a substrate (e.g., a clear plexiglass panel) carrying a phosphorescent material (e.g., coated on an interior side of the panel). The phosphorescent material will saturate within a few minutes of the light source being turned on. When the light source is turned off, the phosphorescent material will continue to emit for up to six hours. Significantly, the emission decay of the phosphorescent material closely follows the adaptation of human eyes to the dark whereby the material remains usefully bright for about a half hour. Specifically, for example, immediately upon turning off the fluorescent fixtures, an occupant can still read fine print. During at least the first ten minutes, an occupant can safely exit the room as obstacles are easily discernable. After thirty minutes, low contrast objects (e.g., a black extension cord on a dark carpet) may become difficult to see.

Similarly, the article of the invention could be of utilization in back lit signage used for advertising or informational display in public venues such as airports, hotels, and the like to provide a level of passive lighting during power outages.

One may now appreciate that the present invention provides a passive light source wherein the phosphorescent-carrying substrate has a high optical transmittance so that the passive light source can be positioned between a primary light source and a viewing environment without unduly compromising the transmission of primary light. Although the invention has been shown and described with respect to certain preferred embodiments, it is evident that equivalent and obvious alterations and modifications will occur to others skilled in the art upon the reading and understanding of this specification. The present invention includes all such alterations and modifications and is limited only by the scope of the following claims.

1. A lighting system comprising a primary light source for supplying primary light to a viewing environment and a passive light source for supplying light to the viewing environment when the primary light source is unavailable and the viewing environment is dark;
wherein the passive light source comprises a substrate carrying a phosphorescent material;
wherein the substrate is positioned between the primary light source and the viewing environment; and
wherein the substrate has an optical transmittance of at least 50%, whereby primary light from the primary light source can be transmitted therethrough to the viewing environment.

2. A lighting system as set forth in claim 1, wherein the substrate has an emission of at least 15.0 mcd/m² at ten minutes and at least 2 mcd/m² at sixty minutes.

3. A lighting system as set forth in claim 1, wherein the substrate has an emission of at least 20.0 mcd/m² at ten minutes and at least 2.8 mcd/m² at sixty minutes.

4. A lighting system as set forth in claim 1, wherein the substrate has an emission of at least 30 mcd/m² at ten minutes.

5. A lighting system as set forth in claim 1, wherein the primary light source is electrically powered.

6. A lighting system as set forth in claim 1, wherein the primary light source is sunlight.

7. A lighting system as set forth in claim 1, wherein the substrate is a clear polymer film.

8. A lighting system as set forth in claim 7, wherein the film is coated with the phosphorescent material in a density corresponding to the desired optical transmittance and emission.

9. A lighting system as set forth in claim 8, further including a cover positioned between the primary light source and the viewing environment, and wherein the coated film is positioned adjacent to a surface of the cover.

10. A lighting system as set forth in claim 1, wherein the substrate is a cover positioned between the primary light source and the viewing environment.

11. A lighting system as set forth in claim 10, wherein the cover is coated with the phosphorescent material in a density corresponding to the desired optical transmittance and emission.

12. A lighting system as set forth in claim 10, wherein the phosphorescent material is embedded or otherwise incorporated into the cover at a density corresponding to the desired optical transmittance and emission.

13. A lighting system as set forth in claim 1, wherein the primary lighting source comprises lighting components and wherein the substrate is an envelope that surrounds the lighting components.

14. A lighting system as set forth in claim 13, wherein the envelope is coated with the phosphorescent material in a density corresponding to the desired optical transmittance and emission.

15. A lighting system as set forth in claim 14, wherein the phosphorescent material is embedded or otherwise incorporated into the envelope at a density corresponding to the desired optical transmittance and emission.

16. A lighting system as set forth in claim 1, wherein the substrate is a window-pane positioned between the primary light source and the viewing environment.

17. A lighting system as set forth in claim 16, wherein the window-pane is coated with the phosphorescent material in a density corresponding to the desired optical transmittance and emission.

18. A lighting system as set forth in claim 16, wherein the phosphorescent material is embedded or otherwise incorporated into the window-pane at a density corresponding to the desired optical transmittance and emission.

19. A lighting system as set forth in claim 1, wherein the substrate is coated with the phosphorescent material.

20. A lighting system as set forth in claim 19, wherein the phosphorescent material is distributed on the substrate to provide useful indicia during dark conditions.
